(19) United States
(12) Patent Application Publication
(10) Pub. No.: US 2026/0269670 A1
(43) Pub. Date: Sep. 10, 2026

(54) COMPACT HAIRPIN WINDING

(71) Applicant: ZF FRIEDRICHSHAFEN AG, Friedrichshafen (DE)

(72) Inventor: Julian WINKLER, Elfershausen (DE)

(21) Appl. No.: 19/471,493

(22) PCT Filed: Mar. 27, 2024
(86) PCT No.: PCT/EP2024/058257

§ 371 Date: Oct. 1, 2025

(30) Foreign Application Priority Data
Apr. 4, 2023 (DE) 10 2023 203 099.3

(51) Int. Cl. H02K 3/28; B60K 1/00

(52) U.S. Cl. CPC H02K 3/28; B60K 1/00

(57) ABSTRACT

A hairpin winding for an electric component of an electric machine that extends over a first outer layer, a plurality of middle layers and a second outer layer. The coil strands have, at their ends on a head side of the winding, per coil, connection pins arranged in the first outer layer with free ends that are axially oriented in a connection region, and at least one of the connection pins has, for each coil, a radial bending region that extends over some of the middle layers. At least one of the two or three parallel-connected coil strands has a slot jump change, and the slot jump change is located in the middle layer adjoining the second outer layer in a slot jump change region which at least partially overlaps with the connection region in circumferential direction of the winding.

### CROSS REFERENCE TO RELATED APPLICATIONS

This is a U.S. national stage of Application No. PCT/EP 2024/058257 filed Mar. 27, 2024. Priority is claimed on German Patent Application No. DE 10 2023 203 099.3 filed Apr. 4, 2023, the contents of which are incorporated herein by reference.

### BACKGROUND OF THE INVENTION

### 1. Field of the Invention

The disclosure is directed to a winding with hairpins for an electric component of an electric machine, such as a stator or a rotor, an electric axle drive and a motor vehicle.

### 2. Description of the Related Art

A winding with hairpins, or hairpin winding, is a winding comprising coils which are formed in each instance by at least one coil strand which in turn comprises a plurality of hairpins which are electrically connected to one another. A hairpin is a shaped bar, generally with a rectangular cross section, which has a U-shape with two parallel conductor members which are monolithically connected to one another along a turn region, also known as a winding head, and accordingly have two ends on a same side. The ends of two hairpins in each instance are electrically conductively connected to one another so that the hairpins are connected in series to form a coil strand. One or more parallel-connected coil strands forms a coil. The ends of the coil strands which are formed in each instance by a free end of a hairpin or I-pin terminating the respective coil strand are referred to as connection pins. In the case of coil strands in a lamination stack of a toroidal stator, the hairpins lie in parallel, axially extending slots in a plurality of winding layers or layers. The winding layers comprise two layers delimiting the winding which can be referred to as first and second outer layers or, for purposes of differentiation, as radial outer layer and radially inner layer. There is a plurality of middle layers therebetween.

The interconnection of the hairpins with one another and with the individual phases and their arrangement in determined slots and determined layers characterize the winding scheme of the winding, often also referred to merely as winding. The winding is configured in such a way that an electric machine in which the winding is applied has a smooth operation and only produces low operating noise. The occurrence of circulating currents and harmonics is to be prevented, and the most uniform possible mutual induction of parallel coil strands should be achieved, which leads to the most homogeneous possible rotating, superimposed magnetic field. At the same time, the axial installation space that is taken up on the winding head side by a winding inserted in a winding body of a rotor or stator and that extends past a winding body should be kept at a minimum.

### SUMMARY OF THE INVENTION

For the description of a winding or winding scheme, the side on which the hairpins are interconnected with one another is referred to as the twist side. The opposite side, on which the winding heads are located, will be referred to as the head side. The spacing of the two parallel conductor members of a hairpin is determined by the spacing of the two slots in which the two conductor members of the hairpin are located and is given by the quantity of jumped-over slots plus one and is designated as winding step when referring to the winding or as slot jump when referring to the winding body in which the winding is inserted.

In general, the conductor members of the hairpins of a winding have a same spacing relative to one another which corresponds to a standard winding step. They are called standard hairpins. For example, if a winding has a hole count of three, then two or three parallel coil strands are guided in three immediately adjacent slots and are provided for connecting to a same phase. Accordingly, in a winding for three phases, there results a standard winding step of nine.

On the head side, owing to the uniform winding step, the standard hairpins form a pattern that is uniform over the circumference with winding heads extending in parallel, except for in the region of the connection pins and in regions where a slot jump change takes place. Within the meaning of the present description, a “slot jump change” means when coil strands jump over a quantity of slots greater or less than an otherwise constant quantity of jumped-over slots. Accordingly, when there are two or three coil strands guided in immediately adjacent slots, the coil strands switch positions relative to one another; that is, the slot jumps change in this case rather than remaining the same.

In order for the connection pins of a coil strand to be arranged close together so as to be easily connectable to a busbar, the coil strand must undergo at least one change in winding direction in the winding. For example, if the connection pins are provided in the radially inner layer, the coil strand starts in the radially inner layer, continues over the middle layers in one winding direction until the radially outer layer where it changes winding direction, and then continues over the middle layers in the opposite winding direction until it arrives in the inner radial winding layer again. A layer change takes place after every passage through a slot except for in the region of the change of direction. The layer change happens on the twist side in that the contact regions of two hairpins which are electrically connected one behind the other are shaped toward one another and welded together radially one behind the other. A corresponding radial offset is formed in the winding head on the head side so that the two parallel conductor members of a hairpin can be arranged tension-free in two adjacent layers at a slight offset relative to one another.

The region in which the change of direction is realized is referred to as the return region. The hairpins used there are referred to as return hairpins and, like the standard hairpins, are located next to one another considered radially and are designed for a standard winding step, their parallel conductor members being arranged in one layer in this case. As it relates to a coil, the return region refers to that region in which the two or three coil strands of the coil undergo the change in winding direction and is delimited by the respective outer slots occupied by the conductor members in question. A slot jump change can also take place in a return region; however, the return regions located in an outer layer should not be considered as slot jump change regions within the meaning of the present description.

In order to change a winding scheme, the coil strands which generally adhere to a fixed sequence in the winding direction when passing through the respective directly adjacent slots can be switched in their sequence independent from a change in the winding direction, as a result of which individual coil strands deviate from a standard slot jump corresponding to a standard winding step. A slot jump change then takes place. During a slot jump change, the relevant hairpins of the two or three coil strands lie radially one above the other, as a result of which winding heads which are higher than the winding heads of the standard pins protrude from the winding in this area.

It is an object of one aspect of the invention to provide a hairpin winding having a compact head side with the smallest possible installation space requirement.

A hairpin winding for an electric component of an electric machine with at least one phase, a hole count of at least three, and two or three parallel-connected coil strands per coil and phase has the following features. The hairpin winding extends over a first outer layer, a plurality of middle layers and a second outer layer, the coil strands having at their ends, per coil, connection pins which are arranged on a head side of the winding in the first outer layer with free ends which are axially oriented in a connection region. The connection pins must not protrude from the winding body within the connection region extending over an angle range in a winding inserted in a winding body. They can have a bending region in circumferential direction of the winding so that the free ends are guided in the connection region. It is compulsory that, for each coil, at least one of the connection pins has a radial bending region which extends over some of the middle layers, and at least one of the two or three parallel-connected coil strands has a slot jump change per coil and phase. According to one aspect of the invention, the slot jump change is located in the middle layer adjoining the second outer layer in a slot jump change region which at least partially overlaps with the connection region in circumferential direction of the winding. Radial bending regions of the connection pins do not collide with the winding heads of the hairpins having a larger winding head height because, per coil, a slot jump change region in which hairpins with a larger winding head height protrude from the winding and a connection region in which the connection pins extend axially so as to protrude from the winding at least partially overlap, but the hairpins making a slot jump change lie in a middle layer which adjoins the outer layer in which the connection pins are not arranged. The head side of the winding can be formed comparatively flatter, which results in a compact winding.

It is advantageous when the radial bending regions extend to the middle layer adjoining the second outer layer. In this way, the bending regions overlap the winding heads at the standard height and the free end of the connection pin is displaced far radially outward.

At least one of the connection pins has a bending region in circumferential direction of the winding so as to situate the free ends of the connection pins of a coil, and, therefore, the connection region, in such a way that they overlap as extensively as possible with the bending region and to guide them as close to one another as possible. There can be connection pins which have only one bending region in circumferential direction and connection pins which additionally have a radial bending region.

A stator for an electric machine comprising a winding according to one aspect of the invention is advantageous.

Depending on the given connection conditions, it may be advantageous that the first outer layer is the radially outermost outer layer at the stator. Alternatively, it may be advantageous when the first outer layer is the radially innermost outer layer at the stator.

An electric machine for an electric axle drive with a stator according to one aspect of the invention is also advantageous. An electric axle drive for a motor vehicle which has an axle drive according to one aspect of the invention and a motor vehicle with an axle drive according to one aspect of the invention are likewise advantageous.

### BRIEF DESCRIPTION OF THE DRAWINGS

The invention will be described in the following referring to an embodiment example shown in the drawings. The drawings show:

FIG. 1A is a notional head-side portion of a hairpin winding inserted in a coil body/stator to illustrate the problem to be solved by the invention;

FIG. 1B is an enlarged section of the diagram from FIG. 1A;

FIG. 2 is a first view of a head-side portion of a hairpin winding inserted in a coil body; and

FIG. 3 is a second view of the head-side portion shown in FIG. 2 of a hairpin winding inserted in a coil body.

### DETAILED DESCRIPTION OF THE PRESENTLY PREFERRED EMBODIMENTS

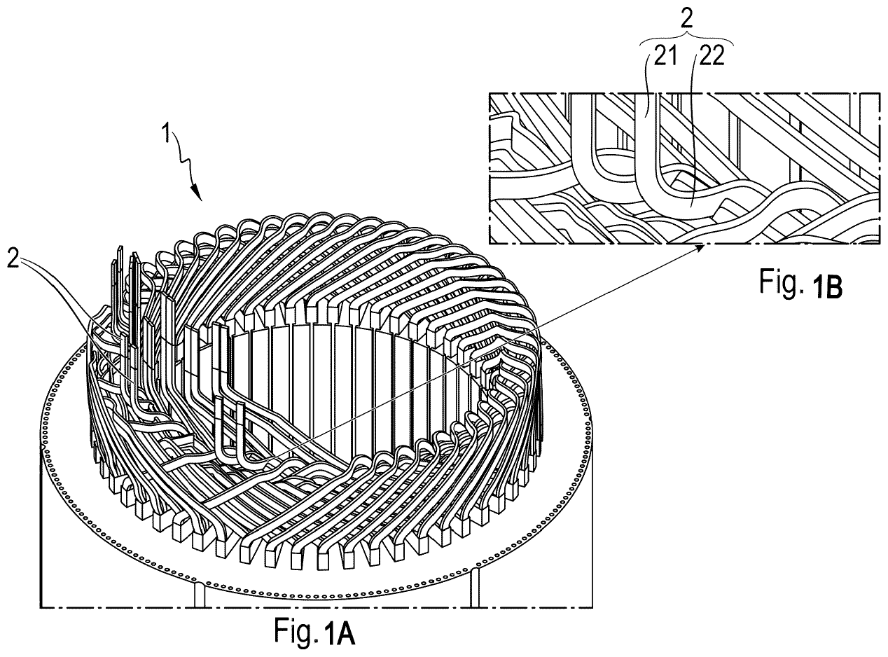

As in a prior art known from practice, a winding according to the invention has three phases, a hole count of three, and two or three parallel-connected coil strands per coil and phase. FIG. 1A shows the head side 1 of such a coil inserted in a winding body. In order to illustrate the problem to be solved, the bending region of the connection pins 2, the winding heads of the hairpins with a slot jump change are shown intersecting. An enlarged section is shown in FIG. 1B. Accordingly, FIGS. 1A and 1B show a notional winding and not a winding according to an actual prior art.

The coil strands comprise, in each instance, a plurality of hairpins connected in series, the ends of the coil strands being formed on the head side 1 of the winding in an outer layer L1, L2 of the winding by a connection pin 2 in each instance which is embodied as a modified hairpin or an I-pin. The two layers delimiting the winding are considered to be outer layers L1, L2 regardless of whether they are located radially inwardly or radially outwardly at a winding inserted in a winding body. A plurality of middle layers Lm are located therebetween. The hairpins comprise, in each instance, two parallel conductor members with two ends which form, in each instance, a contact region on a twist side of the winding, not shown in the drawings. Each contact region is welded with a contact region of a hairpin arranged upstream or downstream in series, forming a weld joint. On the head side, the conductor members are monolithically connected to one another in each instance via a winding head. The two parallel conductor members have a distance from one another which corresponds to a winding step and is given by the quantity of jumped-over slots plus one.

The winding extends in one winding direction starting in a first outer layer L1 and proceeding over a plurality of middle layers Lm to a second outer layer L2 where the winding direction changes, and then back to the first outer layer L1 via the middle layers Lm. One of the two outer layers L1, L2 may also be referred to as an inner layer referring to the cylindrical shape of the hairpin winding.

The hairpins of the winding generally have a standard winding step equal to the product of the hole count and quantity of phases, a quantity of slots being jumped over in each instance.

In order to change the winding scheme, slot jump changes are also provided. A slot jump change occurs when a hairpin has a winding step of ten or eleven, for example, deviating from a standard winding step, for example, a winding step of nine.

In a slot jump change in a winding with three phases with two winding strands in each instance, a hairpin of the first of the two respective winding strands has a winding step equal to the standard winding step plus one and a hairpin of the second of the two respective winding strands has a winding step equal to the standard winding step minus one. Consequently, the two hairpins in question of coil strands of a coil lie axially one above the other. As a result, the coil strands switch their positions relative to one another in the winding direction. A new winding scheme results for two respective parallel-connected coil strands.

In a slot jump change in a winding with three phases with three winding strands in each instance, a hairpin of the first of the three respective winding strands has a winding step equal to the standard winding step plus two, a hairpin of the second of the three respective winding strands has a winding step equal to the standard winding step, and a hairpin of the third of the three winding strands has a winding step equal to the standard winding step minus two. Consequently, the three hairpins in question of a winding lie axially one above the other. As a result, the three coil strands switch their positions in the winding direction relative to one another in the slots of the winding body. A new winding scheme results for three respective parallel-connected coil strands.

The term “winding step” relates to the winding. The term “slot jump” has the same meaning but refers to the winding body. The region in which the hairpins are arranged which have a winding step deviating from a standard winding step is therefore regarded as the slot jump change region. Return regions which are arranged in an outer layer and which may likewise comprise hairpins that can comprise a winding step deviating from a standard winding step are not to be understood as slot jump change regions within the meaning of this description.

Hairpins with a different winding step have different maximum winding head heights. These result because the winding heads of the rest of the hairpins are formed in each instance approximately by an isosceles triangle whose equal legs form a same angle with one another regardless of the value of the winding step. Accordingly, the winding heads of three hairpins, two of which carry out a slot jump change, lie axially one above the other. The hairpin with the largest winding step has a winding head with the largest maximum winding head height.

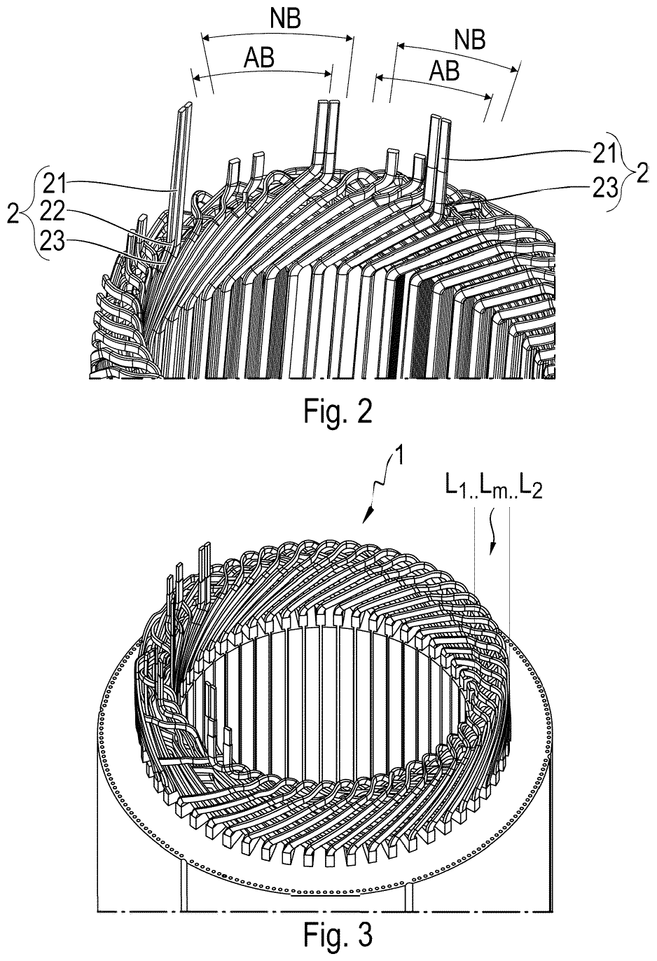

So that the axial installation height of a winding according to one aspect of the invention is kept small on the head side, it is key to the invention that the slot jump change not be arranged in just any middle layer Lm but rather, as can be seen from FIGS. 2 and 3, in the middle layer Lm which adjoins the second outer layer L2 when the connection pins are arranged in first outer layer L1.

The connection pins 1 protrude from the winding body in the first outer layer. At least one of the connection pins 1 per winding has a radial bending region 22 which runs in radial direction and which extends radially over one or more middle layers Lm of the winding. The radial bending region 22 allows a great flexibility in the distribution of phase connections and star point connections. In the present example, two first connection pins 1 of the two coil strands of a coil are carried out, per phase, without a radial bending region 22 and are connectable in pairs to a phase in each instance via a bus bar. The respective two second connection pins 1 have a radial bending region 22 so that their free ends are connectable to a star point via a busbar so as to be radially offset relative to the first connection pins.

A radial displacement of the free end 21 can be carried out by the radial bending region 22 with the connection pin 1 in question, for example, via one or more, or all, of the middle layers Lm. Further, the connection pins 2 can have a bending region in circumferential direction 23 that can be adjoined by a radial bending region 22. The free end 21 of the connection pins 2 can accordingly be offset radially as well as in circumferential direction to the location where it exits from the winding body. The offset in circumferential direction is effected such that the connection region AB in which the free ends of the connection pins 2 are located at least overlap with the slot jump change region NB in which the hairpins with a slot jump change are located.

Accordingly, as a result of the bending regions 22, 23 of the connection pins 2 in combination with a freely selectable axial length adjoining the free ends 21 thereof, a greater flexibility results for distributing the phase connections and star point connections. But in order that the axial installation space taken up by the winding head is not increased by the radial bending regions 22 which span the winding heads in the middle layers Lm, the slot jump changes in a slot jump change region are arranged in a middle layer Lm which is located at the greatest possible distance from the outer layer in which the connection pins 1 protrude from the coil body.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-9. (canceled)

10. A hairpin winding for an electric component of an electric machine with at least one phase, a hole count of at least three, and two or three parallel-connected coil strands per coil and phase, wherein the hairpin winding extends over a first outer layer, a plurality of middle layers and a second outer layer, wherein each coil strand has, at its ends on a head side of the winding, per coil, connection pins arranged in the first outer layer with free ends which are axially oriented in a connection region, and at least one of the connection pins has, for each coil, a radial bending region which extends over some of the middle layers, wherein at least one of the two or three parallel-connected coil strands has a slot jump change, the slot jump change is located in the middle layer adjoining the second outer layer in a slot jump change region which at least partially overlaps with the connection region in circumferential direction of the winding.

11. The hairpin winding according to claim 10, wherein the radial bending regions extend to the middle layer adjoining the second outer layer.

12. The hairpin winding according to claim 10, wherein at least one of the connection pins has, per coil, a bending region in circumferential direction of the winding.

13. A stator for an electric machine, comprising:
a hairpin winding for an electric component of an electric machine with at least one phase, a hole count of at least three, and two or three parallel-connected coil strands per coil and phase,
wherein the hairpin winding extends over a first outer layer, a plurality of middle layers and a second outer layer,
wherein each coil strand has, at its ends on a head side of the winding, per coil, connection pins arranged in the first outer layer with free ends which are axially oriented in a connection region, and at least one of the connection pins has, for each coil, a radial bending region which extends over some of the middle layers,
wherein at least one of the two or three parallel-connected coil strands has a slot jump change, the slot jump change is located in the middle layer adjoining the second outer layer in a slot jump change region which at least partially overlaps with the connection region in circumferential direction of the winding.

14. The stator according to claim 13, wherein the first outer layer is a radially outermost outer layer at the stator.

15. The stator according to claim 14, wherein the first outer layer is a radially innermost outer layer at the stator.

16. An electric machine for an electric axle drive, comprising:
a stator comprising:
a hairpin winding for an electric component of an electric machine with at least one phase, a hole count of at least three, and two or three parallel-connected coil strands per coil and phase,
wherein the hairpin winding extends over a first outer layer, a plurality of middle layers and a second outer layer,
wherein each coil strand has, at its ends on a head side of the winding, per coil, connection pins arranged in the first outer layer with free ends which are axially oriented in a connection region, and at least one of the connection pins has, for each coil, a radial bending region which extends over some of the middle layers,
wherein at least one of the two or three parallel-connected coil strands has a slot jump change, the slot jump change is located in the middle layer adjoining the second outer layer in a slot jump change region which at least partially overlaps with the connection region in circumferential direction of the winding,
wherein the first outer layer is a radially outermost outer layer at the stator, and
wherein the first outer layer is a radially innermost outer layer at the stator.

17. The electric machine according to claim 16, wherein the electric machine is integrated into an electric axle drive for a motor vehicle.

18. The electric machine according to claim 17, wherein the electric axle drive is an electric axle drive for a motor vehicle.
